(19) United States
(12) Patent Application Publication
(10) Pub. No.: US 2008/0258498 A1
(43) Pub. Date: Oct. 23, 2008

(54) TRUSS STRUCTURE FOR PICKUP BED AREA

(75) Inventors: Ceby Philip, Powell, OH (US); Eric Boettcher, Columbus, OH (US)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 11/738,010

(22) Filed: Apr. 20, 2007

(51) Int. Cl. B62D 33/00

(52) U.S. Cl. 296/182.1

(57) ABSTRACT

A truss structure for a vehicle having a bed area is provided and includes multiple truss members. The truss structure resides in each sidewall of the bed area. The truss members are made up of either stamped structures or a combination of roll-formed structures and stamped structures.

### BACKGROUND OF THE INVENTION

1. Field of the Invention

The present invention relates to an automotive vehicle and more specifically to a truss structure for use in a pickup truck bed area.

2. Description of Related Art

FIGS. 1A and 1B show a conventional unibody pickup truck bed area 200. The bed area 200 includes two side walls 202, a front wall 204, a floor 206, and a rear tailgate (not shown). The sidewalls 202 are made up of an inner sidewall 208, an outer sidewall or fender 210, and a stiffening panel 212. The stiffening panel 212 is a stamped-metal panel that resides between the inner sidewall 208 and the outer sidewall 210. The stiffening panel 212 provides structural support to each sidewall 202.

A disadvantage with the conventional pickup truck bed design, however, relates to flexibility in design and controlling manufacturing costs associated with the flexible designs. In today's automotive market, automobile manufacturers have designed and manufactured pick-up trucks that can be configured to support beds of varying length. This trend, however, has resulted in an increase in manufacturing costs and more specifically tooling costs. For example, because the stiffening panel is a stamped component of the bed area, manufacturing (stamping) an appropriate sized stiffening panel for each bed length would require multiple dies. Multiple dies, however, result in an increase in manufacturing costs and ultimately vehicle costs. On the other hand, the truss structure of the present invention includes multiple roll-formed members. Roll-formed members can be cut to any length and simply rolled to the desired shaped. The equipment required to manufacture roll-formed members has the capability to produce roll-formed members of any length. Costly dies are not required in the manufacturing process of roll-formed members. Therefore, with the use of the truss structure of the present invention manufacturing costs can be controlled without sacrificing flexibility.

Thus, what is required is an improved stiffening structure to improve rigidity and safety and increase efficiency in manufacturing thereby decreasing tooling costs.

### SUMMARY OF THE INVENTION

In accordance with one aspect, the present invention overcomes the above mentioned disadvantages by providing a truss structure for a vehicle. The truss structure resides in a sidewall of the vehicle and includes multiple truss members. A first truss member is joined to a rear pillar of the vehicle and extends in a rear direction generally parallel to a bed floor of the vehicle. Further, the first truss is elevated above the bed floor. A second truss member, joined to the first truss member, extends in a downward direction generally perpendicular to the bed floor and is joined to the bed floor. A third truss member, joined to the first truss member behind the second truss member, extends in a downward direction diagonally away from the second truss member and is joined to the bed floor. A fourth truss member, joined to a rear portion of the first truss member, extends in a downward direction generally perpendicular to the bed floor and is joined to the bed floor. A fifth truss member is joined to the bed floor between the second truss member and the third truss member. The fifth truss member also connects the second truss member and the third truss member. An optional sixth truss member, joined to the rear pillar, extends in a downward direction diagonally toward the second truss member and is joined to the bed floor.

Additional benefits and advantages of the present invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings that form a part of the specification.

FIG. 1 is a perspective view of a bed area of a pickup truck showing a conventional stiffening panel.

FIG. 1B is a cross-sectional view taken along line 1B-1B as shown in FIG. 1A.

FIG. 2 is a perspective view of a bed area of a pickup truck showing a truss structure in accordance with the present invention.

FIG. 3 is a perspective view of the bed area of the pickup truck showing an energy load path in the event of a rear collision.

FIG. 4 is a side view of the bed area of the pickup truck showing the truss structure in accordance with the present invention.

FIG. 5 is a cross-sectional view taken along line 5-5 as shown in FIG. 4.

FIG. 6 is a side view of a bed area of a pickup truck showing a second embodiment of the truss structure.

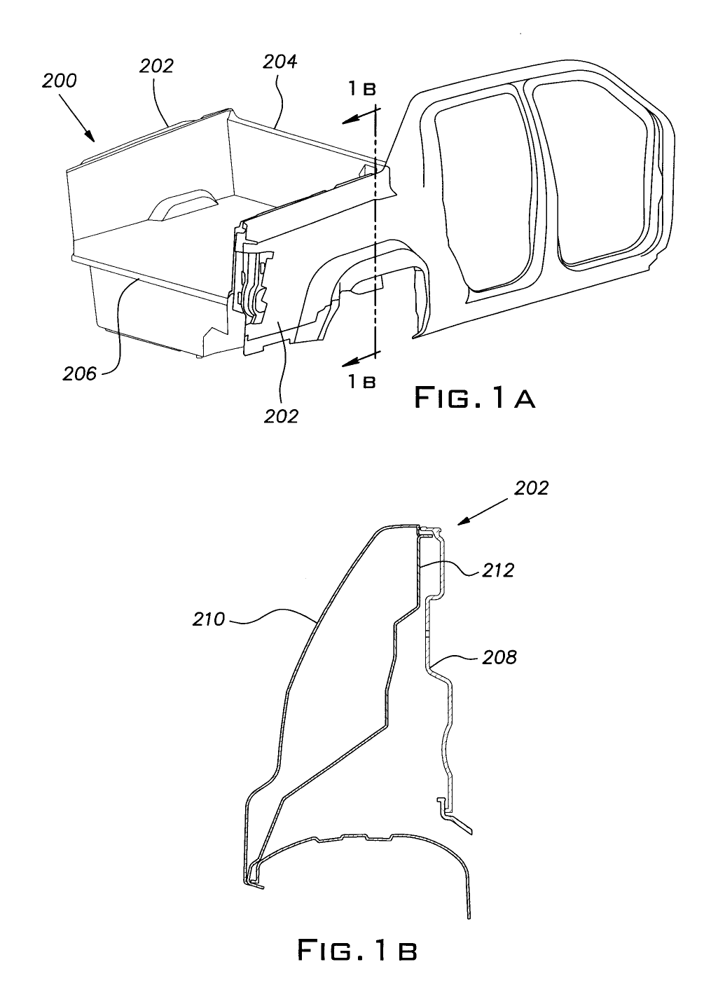

### DETAILED DESCRIPTION OF THE INVENTION

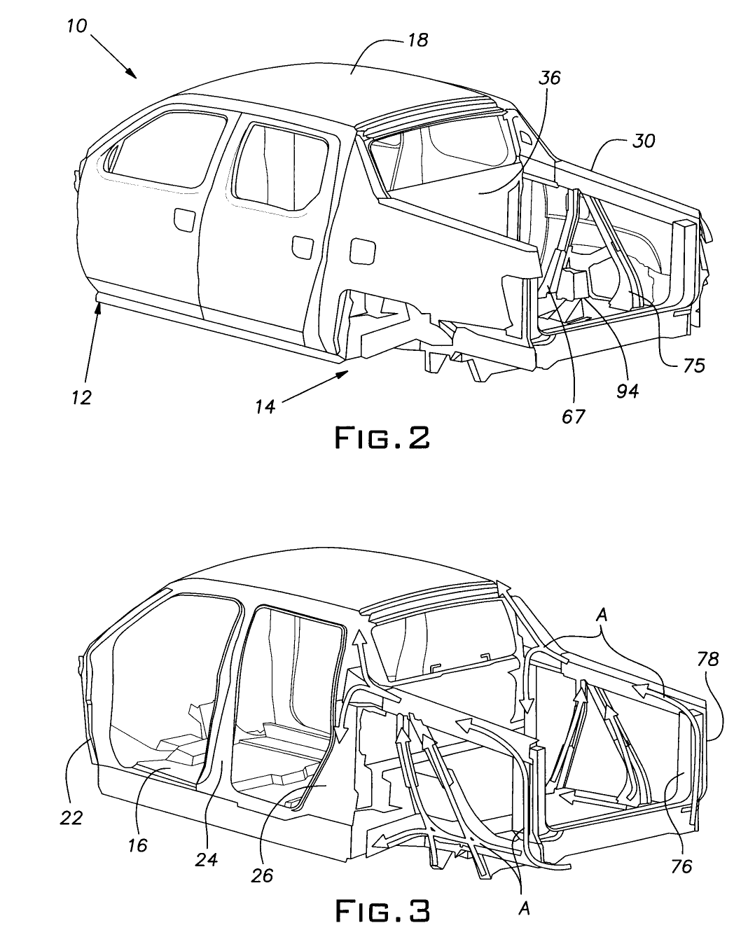

Referring now to the drawings, FIGS. 2-5 show a first embodiment of the present invention. FIGS. 2-4 show an automotive vehicle and more specifically a pickup truck 10 that includes a passenger area 12 and a bed area 14.

The passenger area 12 includes a floor 16, a roof 18, multiple doors 20, two front pillars 22, two intermediate pillars 24 and two rear pillars 26. The front pillars 22, the intermediate pillars 24 and the rear pillars 26 extend between the roof 18 and the floor 16 of the passenger area 12, thereby joining the roof 18 to the floor 16, thus, forming the framework for the passenger area 12.

The bed area 14 includes a floor 28, two sidewalls 30, each sidewall having an inner panel 32 and an outer panel 34, a front wall 36, and a rear tailgate (not shown). A front portion of each sidewall 30 is joined to each rear pillar 26 by any means known in the art. Further, the front wall 36 extends between each rear pillar 26 and is joined to each rear pillar 26 by any means known in the art. Thus, the front wall 36 also serves as a rear wall for the passenger area 12. Alternatively, the front wall 36 may be spaced from the passenger area rear wall, as in known in the art. A truss structure 40, joined to the floor 28 of the bed area 14, resides between the inner panel 32 and the outer panel 34 of each sidewall 30.

Referring to FIGS. 3-5, the truss structure 40 includes a first truss member or upper truss 42, a second truss member or forward truss 44, a third truss member or rear-diagonal truss 46, a fourth truss member or rear truss 48, and a fifth truss member or connecting truss 50. The truss structure 40 provides multiple load paths to dissipate energy in the event of a rear end collision and also provides flexibility in manufacturing, thereby reducing manufacturing costs.

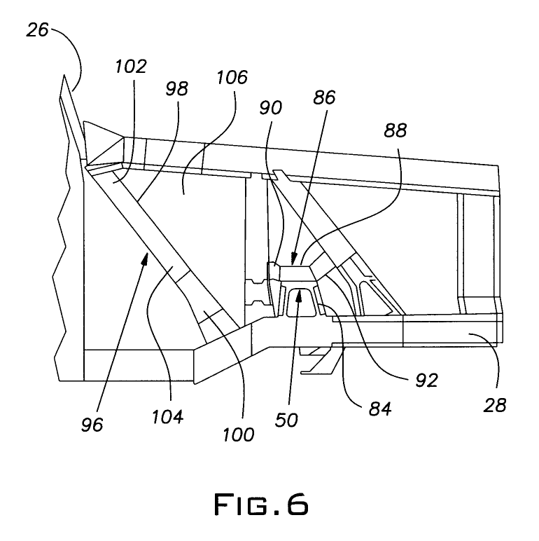

The upper truss 42 is oriented in a forward-rearward direction and is generally parallel to the floor 28 of the bed area 14. Both the inner panel 32 and the outer panel 34 are joined to the upper truss 42 by any means known in the art, as shown in FIG. 5. The upper truss 42 includes a substantially horizontal-upper support 52 and an upper-transition-joining portion 54. The upper support 52 is a one-piece roll-formed member having a front portion 56 and a rear portion 58. The rear portion 58 of the upper member 52 is attached to the rear truss 48 as will be explained further below.

The upper-transition-joining portion 54 is a stamped member and functions as a transition joint between a roll-formed member and a stamped member. Thus, the upper-transition-joining portion 54 joins the front portion 56 of the upper member 52 to an upper portion of each rear pillar 26 at each rear corner of the passenger area 12.

The forward truss 44 is vertically oriented and is generally perpendicular to the upper truss 42 and the floor 28 of the bed area 14. The forward truss 44 includes a vertical support 60 extending downward from the upper truss 42 and a vertical-transition-joining portion 62 extending upward from the floor 28 of the bed area 14. The vertical support 60 is a one-piece roll-formed member and includes an upper end 64 and a lower end 66. The upper end 64 of the vertical support 60 is joined to the upper truss 42 rear of and adjacent to the upper-transition-joining portion 54.

The vertical-transition-joining portion 62 is a stamped member and functions as a transition joint between a roll-formed member and a stamped member. Thus, the vertical-transition-joining portion 62 joins the lower end 66 of the vertical support 60 to the floor 28 of the bed area 14. A reinforcement member 67 (see FIG. 2) is attached to an inside surface of the vertical-transition-joining portion 62 and to the floor 28 of the bed area 14 to provide additional support to the forward truss 44.

The rear-diagonal truss 46 is diagonally oriented with respect to the upper truss 42 and the floor 28 and includes a diagonal support 68 and a diagonal-transition-joining portion 70. The diagonal support 68 is a one-piece roll-formed member and includes an upper end 72 and a lower end 74. The upper end 72 of the diagonal support 68 is joined to the upper truss 42 rear of and adjacent to the forward truss 44. The diagonal support 68 extends downwardly at an angle with respect to the upper truss 42 toward the rear truss 48.

The diagonal-transition-joining portion 70 is a stamped member and functions as a transition joint between a roll-formed member and a stamped member. The diagonal-transition-joining portion 70 extends upwardly at an angle with respect to the floor 28 toward the forward truss 44 and attaches to the lower end 74 of the diagonal support 68. Thus, the diagonal-transition-joining portion 70 joins the lower end 74 of the diagonal support 68 to the floor 28 of the bed area 14 approximately halfway between the forward truss 44 and the rear truss 48. Therefore, the rear-diagonal truss 46 along with the forward truss 44 and the floor 28 form a triangular shaped structure 73 within the sidewall 30. The triangular shaped structure 73 provides a rigid but flexible support system for the sidewalls 30 of the vehicle 10. A reinforcement member 75 (see FIG. 2) is attached to an inside surface of the diagonal-transition-joining portion 70 and to the floor 28 of the bed area 14 to provide additional support to the rear-diagonal truss 46.

The rear truss 48 is vertically oriented and is generally perpendicular to the upper truss 42 and to the floor 28 of the bed area 14. Further, the rear truss 48 is generally parallel to the forward truss 44. The rear truss 48 includes a stamped-inner panel 76 and a stamped-outer panel 78. The inner panel 76 and outer panel 78 are joined to one another by any means known in the art, such as but not limited to screws, riveting, welding, etc. The rear truss 48 includes an upper end 80 and a lower end 82. The upper end 80 is joined to the rear portion 58 of the upper support 52 utilizing a transition-joint-construction method. Further, the lower end 82 is joined to the floor 28 of the bed area 14 using the same transition-joint-construction method.

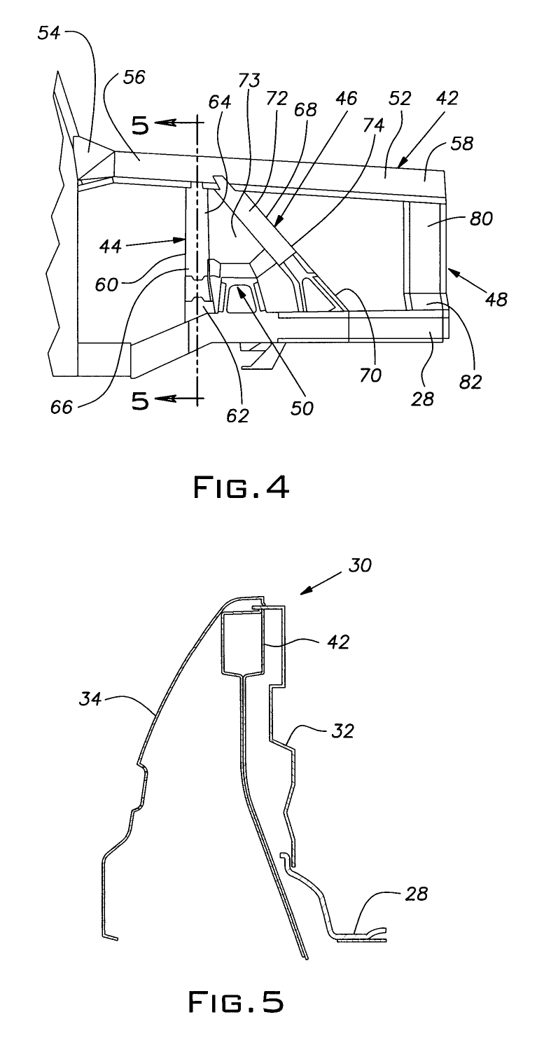

The connecting truss 50 is shown in FIG. 4 however, for clarity the connecting truss 50 will be described with reference to FIG. 6. The connecting truss 50 is a one-piece stamped member and includes a base 84 and a connection arm 86. The base 84 is joined to the floor 28 of the bed area 14 between the forward truss 44 and the rear-diagonal truss 46. The connection arm 86 includes a horizontal portion 88, a first extension arm 90 and a second extension arm 92. The horizontal portion 88 is joined to the top of the base 84. The first extension arm 90 extends from the horizontal portion 88 upwardly angled with respect to the horizontal portion 88 in a forward direction. The first extension arm 90 is joined to the lower end 66 of the vertical support 60. The second extension arm 92 extends from the horizontal portion 88 upwardly angled with respect to the horizontal portion 88 in a rearward direction. The second extension arm 92 is joined to the lower end 74 of the diagonal support 68. Thus, the connection arm 86 essentially resides inside the triangular shaped structure 73 and provides a connection between the forward truss 44, the rear-diagonal truss 46 and the floor 28 to further strengthen the triangular shaped structure 73. A reinforcement member 94 (see FIG. 2) is attached to an inside surface of the base 84 and to the floor 28 of the bed area 14 to provide additional support to the connecting truss 50.

Referring now to FIG. 3, an energy load path is represented by the arrows A. The load path A is the path that the energy load resulting from a rear end collision travels. As FIG. 3 illustrates, the load from a rear end collision is dispersed through each member of the truss structure 40. More specifically, the load is transmitted from the floor 28 of the bed area 14 upward to the upper truss 42 through the forward truss 44, the rear-diagonal truss 46 and the rear truss 48. The energy is then transmitted along the upper truss 42 toward the passenger area 12 and finally upwardly and downwardly along each rear pillar 26. Thus, because the truss structure 40 has multiple truss members the load is communicated over multiple paths. Therefore, the truss structure 40 is able to absorb and dissipate the energy more effectively than the conventional stiffening panel described above.

Referring again to FIG. 6, a second embodiment of the present invention is illustrated. In the second embodiment, a sixth truss member or forward-diagonal truss 96 is added between the passenger area 12 of the vehicle 10 and the forward truss 44 to provide additional strength for pickup trucks having a longer bed area 14. The forward-diagonal truss 96 is diagonally oriented with respect to the upper truss 42 and includes a diagonal support 98 and a diagonal-transition-joining portion 100. The diagonal support 98 is a one-piece roll-formed member and includes an upper end 102 and a lower end 104. The upper end 102 of the diagonal support 98 is joined to the upper truss 42 rearwardly adjacent to each rear pillar 26 at the rear corners of the passenger area 12. More specifically, the upper end 102 of the diagonal support 98 is joined to the upper-transition-joining portion 54 of the upper truss 42. The diagonal support 98 extends downwardly at an angle with respect to the upper truss 42 toward the forward truss 44.

The diagonal-transition-joining portion 100 is a stamped member and functions as a transition joint between a roll-formed member and a stamped member. The diagonal-transition-joining portion 100 extends upwardly at an angle with respect to the floor 28 toward the passenger area 12 and attaches to the lower end 104 of the diagonal support 98. Thus, the diagonal-transition-joining portion 100 joins the lower end 104 of the diagonal support 98 to the floor 28 of the bed area 14 forward of, and adjacent to, the forward truss 44. Therefore, the forward-diagonal truss 96 along with the upper truss 42 and the forward truss 44 form a second triangular shaped structure 99 within the sidewall 30. The second triangular shaped structure 99 provides a rigid but flexible support system for the sidewalls 30 of the vehicle 10. A reinforcement member (not shown) is attached to an inside surface of the diagonal-transition-joining portion 100 and to the floor 28 of the bed area 14 to provide additional support to the forward-diagonal truss 96.

It should be noted, in the second embodiment, as the length of the bed area 14 increases the length of the horizontal-upper support 52 of the upper truss 42 increases accordingly. The horizontal-upper support 52, however, is still a one-piece roll-formed member. Because the horizontal-upper support 52 is a one-piece roll-formed member, the length of the upper truss 42 can be adjusted to accommodate pickup truck beds of varying length. Therefore, the truss structure 40 provides flexibility in manufacturing and reduces manufacturing costs.

The above described truss structure includes several roll-formed members combined with several stamped members to provide an efficient method of manufacturing the truss structure while improving rigidity and safety. It should be noted, however, that the roll-formed members can be replaced with stamped members. While this may increase manufacturing costs over the utilization of roll-formed members, the improved efficiency and safety realized from the truss structure would not be sacrificed.

While specific embodiments of the invention have been described and illustrated, it is to be understood that these embodiments are provided by way of example only and that the invention is not to be construed as being limited but only by proper scope of the following claims.

What is claimed is:

1. A truss structure for a vehicle comprising:
a first truss member operatively connected to a rear pillar of the vehicle and extending rearwardly generally parallel to a bed floor of the vehicle, the first truss member being elevated above the bed floor;
a second truss member operatively connected to the first truss member and extending downwardly generally perpendicular to the bed floor, the second truss member being operatively connected to the bed floor;
a third truss member operatively connected to the first truss member rearward of the second truss member and extending downwardly and diagonally away from the second truss member, the third truss member being operatively connected to the bed floor;
a fourth truss member extending generally perpendicular to the bed floor, the fourth truss member comprising an upper end operatively connected to a rear portion of the first truss member and a lower end operatively connected to the bed floor; and
a fifth truss member operatively connected to the bed floor between the second truss member and the third truss member, the fifth truss member operatively connecting the second truss member and the third truss member.

2. The truss structure of claim 1 further comprising a sixth truss member operatively connected to the rear pillar and extending downwardly and diagonally toward the second truss member.

3. The truss structure of claim 2,
wherein the first truss member comprises a roll-formed upper support and an upper-transition-joining portion operatively connecting the upper support to the rear pillar,
wherein the second truss member comprises a roll-formed vertical support operatively connected to the first truss member and a vertical-transition-joining portion operatively connecting the vertical support to the bed floor,
wherein the third truss member comprises a roll-formed diagonal support operatively connected to the first truss member rearward of the second truss member and a diagonal-transition-joining portion operatively connecting the diagonal support to the bed floor, and
wherein the sixth truss member comprises a roll-formed diagonal support, a diagonal-transition-joining portion operatively connecting the diagonal support to the bed floor and a reinforcement member operatively connected to an inside portion of the diagonal-transition-joining portion and to the bed floor.

4. The truss structure of claim 3,
wherein the fourth truss member comprises an inner panel and an outer panel, and
wherein the fifth truss member comprises a base operatively connected to the bed floor and a connection arm operatively connected to a top of the base, the fifth truss member operatively connecting the second and third truss members.

5. The truss structure of claim 1,
wherein the first truss member comprises a roll-formed upper support and an upper-transition-joining portion operatively connecting the upper support to the rear pillar,
wherein the second truss member comprises a roll-formed vertical support operatively connected to the first truss member and a vertical-transition-joining portion operatively connecting the vertical support to the bed floor, and
wherein the third truss member comprises a roll-formed diagonal support operatively connected to the first truss member rearward of the second truss member and a diagonal-transition-joining portion operatively connecting the diagonal support to the bed floor.

6. The truss structure of claim 5,
wherein the fourth truss member comprises an inner panel and an outer panel, and
wherein the fifth truss member comprises a base operatively connected to the bed floor and a connection arm operatively connected to a top of the base, the fifth truss member operatively connecting the second and third truss members.

7. The truss structure of claim 6 further comprising a plurality of reinforcement members operatively connected to an inside surface of the vertical-transition-joining portion, diagonal-transition-joining portion and the base, the reinforcement members being operatively connected to the bed floor.

8. The truss structure of claim 7, wherein the second truss member, the third truss member and the bed floor form a first triangle and wherein the fifth truss member is located inside the triangle.

9. A vehicle comprising:
a bed area comprising a floor, two sidewalls and a front wall; and
a truss structure located in a sidewall of the bed area, the truss structure comprising:
an upper truss operatively connected to the front wall and extending rearwardly generally parallel to the floor of the vehicle, the upper truss being elevated above the floor;
a forward truss operatively connected to the upper truss and extending downwardly generally perpendicular to the floor, the forward truss being operatively connected to the floor;
a rear-diagonal truss operatively connected to the upper truss rearward of the forward truss and extending downwardly and diagonally away from the forward truss member, the rear-diagonal truss being operatively connected to the floor;
a rear truss generally perpendicular to the floor, the rear truss comprising an upper end operatively connected to a rear portion of the upper truss and a lower end operatively connected to the floor; and
a connecting truss operatively connected to the floor between the forward truss and the rear-diagonal truss, the connecting truss operatively connecting the forward truss and the rear-diagonal truss.

10. The vehicle of claim 9,
wherein the upper truss comprises a roll-formed upper support and an upper-transition-joining portion operatively connecting the upper support to the front wall,
wherein the forward truss comprises a roll-formed vertical support operatively connected to the upper truss and a vertical-transition-joining portion operatively connecting the vertical support to the bed floor, and
wherein the rear-diagonal truss comprises a roll-formed diagonal support operatively connected to the upper truss rearward of the forward truss and a diagonal-transition-joining portion operatively connecting the diagonal support to the bed floor.

11. The vehicle of claim 10,
wherein the rear truss comprises an inner panel and an outer panel, and
wherein the connecting truss comprises a base operatively connected to the bed floor and a connection arm operatively connected to a top of the base, the connecting truss operatively connecting the forward truss and rear-diagonal truss.

12. The vehicle of claim 11, wherein the truss structure further comprises a plurality of reinforcement members operatively connected to an inside surface of the vertical-transition-joining portion, diagonal-transition-joining portion and the base, the reinforcement members being operatively connected to the bed floor.

13. The truss structure of claim 12, wherein the forward truss, the rear-diagonal truss and the bed floor form a first triangle and wherein the connecting truss is located inside the triangle.

14. The truss structure of claim 13 further comprising a forward-diagonal truss operatively connected to the front wall and extending downwardly and diagonally toward the forward truss.

15. The truss structure of claim 14, wherein the forward-diagonal truss comprises a roll-formed diagonal support, a diagonal-transition joining portion operatively connecting the diagonal support to the bed floor and a reinforcement member operatively connected to an inside surface of the diagonal-transition-joining portion and to the bed floor.

16. The truss structure of claim 15, wherein the upper truss, the forward truss and the forward-diagonal truss form a second triangle located forward of the first triangle.

17. The vehicle of claim 16, wherein each sidewall comprises an inner panel and an outer panel and wherein the inner panel and the outer panel are operatively connected to the upper truss.
